(19) United States
(12) Patent Application Publication
(10) Pub. No.: US 2025/0121454 A1
(43) Pub. Date: Apr. 17, 2025

(54) LASER PROCESSING APPARATUS, LASER PROCESSING METHOD AND SUBSTRATE DICING METHOD USING THE SAME

(71) Applicant: Samsung Electronics Co., Ltd., Suwon-si (KR)

(72) Inventors: Narae HAN, Suwon-si (KR); Jaeheung LEE, Suwon-si (KR); Namtae HEO, Suwon-si (KR)

(73) Assignee: Samsung Electronics Co., Ltd., Suwon-si (KR)

(21) Appl. No.: 18/732,741

(22) Filed: Jun. 4, 2024

(30) Foreign Application Priority Data
Oct. 17, 2023 (KR) 10-2023-0138650

(51) Int. Cl. B23K 26/06; B23K 26/067; B23K 26/082; B23K 26/38; B23K 26/70; B23K 101/36

(52) U.S. Cl. CPC B23K 26/0648; B23K 26/0676; B23K 26/082; B23K 26/38; B23K 26/704; B23K 2101/36

(57) ABSTRACT

A laser processing apparatus includes a stage configured to support a substrate to be processed, a laser light source configured to generate a laser beam, a mode converter configured to convert the laser beam into a cylindrical vector beam, a polarizing filter configured to polarize the cylindrical vector beam to form a double-o shaped beam in which two beams are arranged adjacent to each other in a first horizontal direction, a condensing lens configured to condense the double-o shaped beam into first and second laser beams at first and second spots apart in the first horizontal direction on the substrate, and a driving portion configured to move the first and second laser beams relatively with respect to the substrate in a second horizontal direction different from the first horizontal direction.

### CROSS-REFERENCE TO RELATED APPLICATIONS

This application claims priority under 35 U.S.C. § 119 to Korean Patent Application No. 10-2023-0138650, filed on Oct. 17, 2023 in the Korean Intellectual Property Office (KIPO), the contents of which are herein incorporated by reference in their entirety.

### BACKGROUND

Various example embodiments relate to one or more of a laser processing apparatus, a laser processing method and a substrate dicing method using the same. More particularly, various example embodiments relate to one or more of a laser processing apparatus configured to cut a substrate by irradiating a laser light into the substrate, a laser processing method using the same, and a substrate dicing method using the same.

In a Grinding After Laser (GAL) process, a laser light may be irradiated into a wafer such as a silicon wafer to apply localized high-density energy to a focal point, to form a stealth dicing layer, and the wafer may be separated or singulated into individual chips by a following tape expansion process. Factors that determine productivity in the GAL process may include a processing speed and/or a number of scans, and since there is a limit to increasing the current acceleration, it may be necessary or desirable to reduce the number of scans so as to improve productivity.

### SUMMARY

Some example embodiments provide a laser processing apparatus that is able to improve productivity.

Alternatively or additionally, some example embodiments provide a laser processing method using the above laser processing apparatus.

Alternatively or additionally, some example embodiments provide a method of dicing a substrate using the above laser processing method.

According to some example embodiments, a laser processing apparatus includes a stage configured to support a substrate to be processed, a laser light source configured to generate a laser beam, a mode converter configured to convert the laser beam into a cylindrical vector beam, a polarizing filter configured to polarize the cylindrical vector beam to form a double-o shaped beam in which two beams are arranged adjacent to each other in a first horizontal direction, a condensing lens configured to condense the double-o shaped beam into first and second laser beams at first and second spots apart in the first horizontal direction on the substrate, and a driving portion configured to move the first and second laser beams relatively with respect to the substrate in a second horizontal direction different from the first horizontal direction.

Alternatively or additionally according to example embodiments, a laser processing apparatus includes a stage configured to support a substrate to be processed, a laser irradiator configured to converge and irradiate first and second laser beams on first and second spots spaced apart in a first horizontal direction on the substrate, and a driving portion configured to move at least one of the stage or the laser irradiator and to move the first and second laser beams with respect to the substrate in a second horizontal direction different from the first horizontal direction. The laser irradiator includes a laser light source configured to generate a laser beam, a mode converter configured to convert the laser beam into a cylindrical vector beam, a polarizing filter configured to polarizing the cylindrical vector beam to form a double-o shaped beam in which two beams are arranged adjacent to each other in the first horizontal direction, a condensing lens on the optical path of the double-o shaped beam and configured to condense the double-o shaped beam into the first and second laser beams on the substrate, and an index adjuster on an optical path of the cylindrical vector beam, on the double-o shaped beam, or on both the optical path and the double-o shaped beam, the index adjuster configured to adjust a spacing distance in the first horizontal direction between the first and second spots.

Alternatively or additionally according to some example embodiments, in a laser processing method, a substrate as an object to be processed is supported on a stage. A laser beam of a cylindrical vector beam is emitted. The cylindrical vector beam is polarized through a polarizing filter to form a double-o shaped beam in which two beams are arranged adjacent to each other in a first horizontal direction. The double-o shaped beam is condensed into first and second laser beams at first and second spots spaced apart in the first horizontal direction on the substrate, through a condensing lens. The first and second laser beams are scanned respectively along two cutting lines on the substrate.

Alternatively or additionally according to example embodiments, a laser processing apparatus may include a laser beam divider configured to divide a laser beam emitted from a laser light source as a single light source into a double-o-shaped beam in which two beams are arranged adjacent to each other in a first horizontal direction, and a condensing lens configured to condense the double-o-shaped beam into first and second laser beams at first and second spots spaced apart from each other in the first horizontal direction on a substrate. In addition, the laser processing apparatus may further include an index adjuster configured to adjust a spacing distance in the first horizontal direction between the first and second spots.

The first and second laser beams may be simultaneously scanned along two cutting lines on the substrate. The distance between the first and second spot positions of the first and second laser beams may be adjusted according to a size of (e.g., a width of and/or a length of) a die that is to be diced from the substrate. The first and second laser beams may be condensed by the condensing lens including a single lens optical system.

Accordingly, the first and second laser beams may be simultaneously scanned while tracking a surface height in real time along two adjacent cutting lines, without increasing a size of the optical system and/or without replacing a new optical system. Thus, a productivity of a dicing process may be improved. Additionally or alternatively, the distance between the two first and second laser beams may be easily adjusted optically.

### BRIEF DESCRIPTION OF THE DRAWINGS

Various example embodiments will be more clearly understood from the following detailed description taken in conjunction with the accompanying drawings. FIGS. 1 to 17 represent non-limiting, example embodiments as described herein.

FIG. 1 is a perspective view illustrating a laser processing apparatus in accordance with some example embodiments.

FIG. 2 is a block diagram illustrating a laser irradiator of FIG. 1.

FIG. 3A is a graph illustrating a shape and an intensity distribution in a radial direction of a laser beam emitted from a laser light source.

FIG. 3B is a graph illustrating a shape and an intensity distribution in a radial direction of a converted laser beam converted by a mode converter.

FIG. 4 is a cross-sectional view illustrating a beam expander that expands a diameter of the converted laser beam.

FIG. 5 is a diagram illustrating a shape and polarization of a filtered beam of a cylindrical incident beam with azimuthal polarization after passing through a polarization filter.

FIG. 6 is a diagram illustrating a shape and polarization of a filtered beam of a cylindrical incident beam with radial polarization after passing through a polarization filter.

FIG. 7A is a graph illustrating a shape and wavefront of a filtered beam after passing through a polarizing filter.

FIG. 7B is a graph illustrating a shape and wavefront of a filtered beam after passing through a spatial light modulator.

FIG. 7C is a graph illustrating a shape and wavefront of first and second laser beams collected by a condenser lens.

FIG. 8 is a flow chart illustrating a laser processing method in accordance with some example embodiments.

FIG. 9 is a cross-sectional view illustrating a wafer on which two first and second laser beams are irradiated.

FIG. 10 is a plan view illustrating two cutting lines on a wafer along which the first and second laser beams of FIG. 9 are scanned.

FIG. 11 is a perspective view illustrating the first and second laser beams irradiated along two cutting lines in FIG. 10.

FIG. 12 is a flow chart illustrating a substrate dicing method in accordance with some example embodiments.

FIGS. 13 to 17 are views illustrating a substrate dicing method in accordance with some example embodiments.

### DETAILED DESCRIPTION

Hereinafter, various example embodiments will be explained in detail with reference to the accompanying drawings.

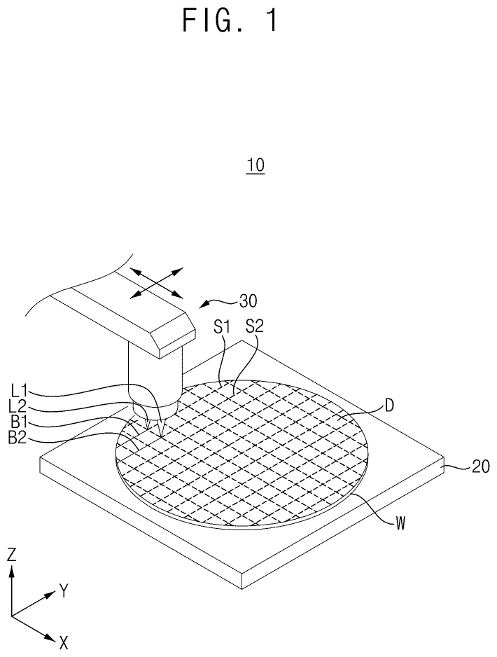

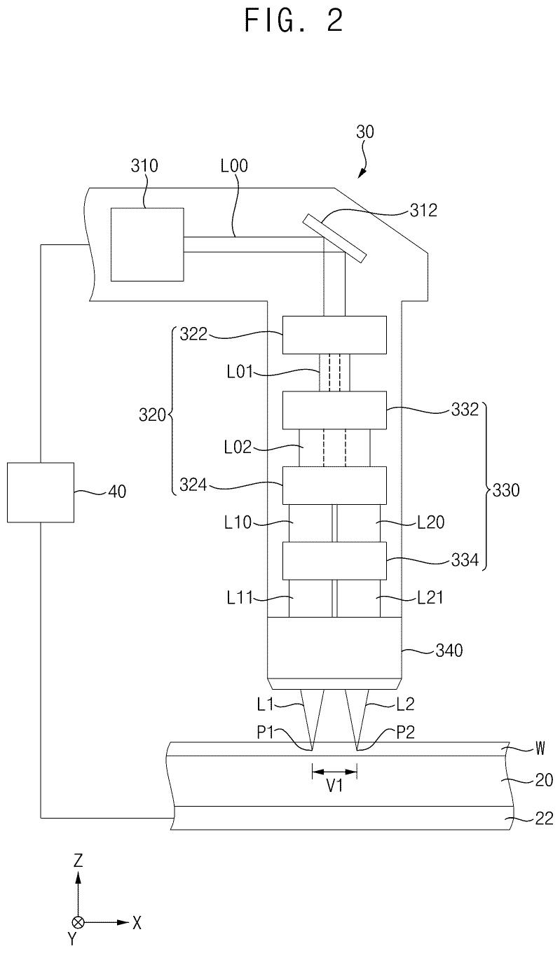

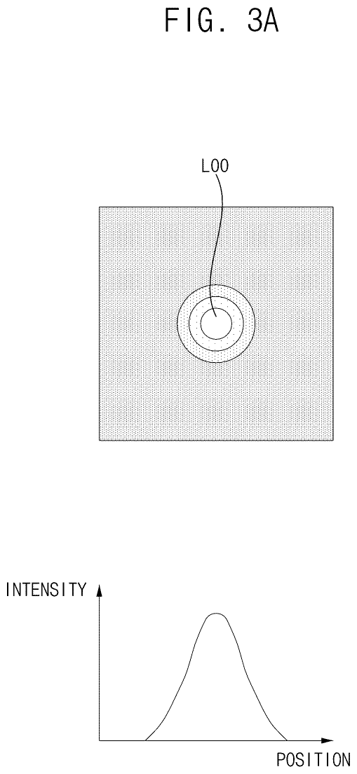

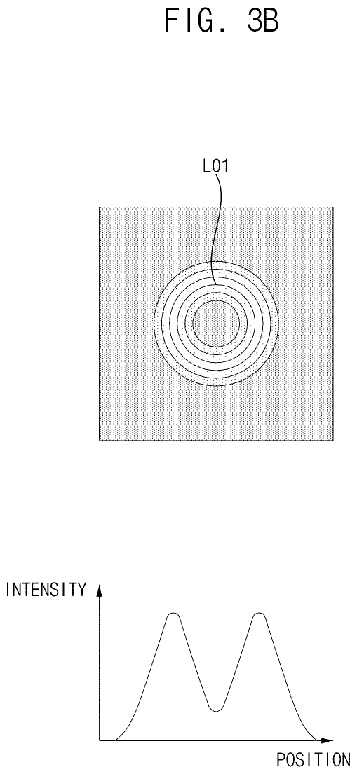

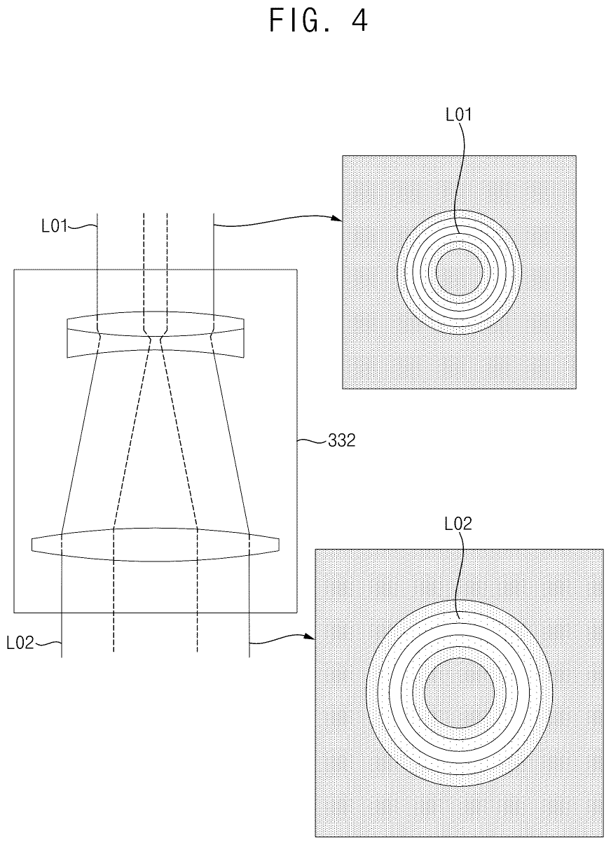

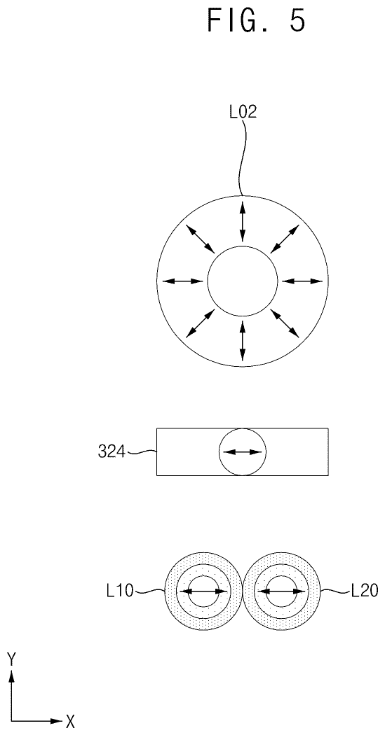

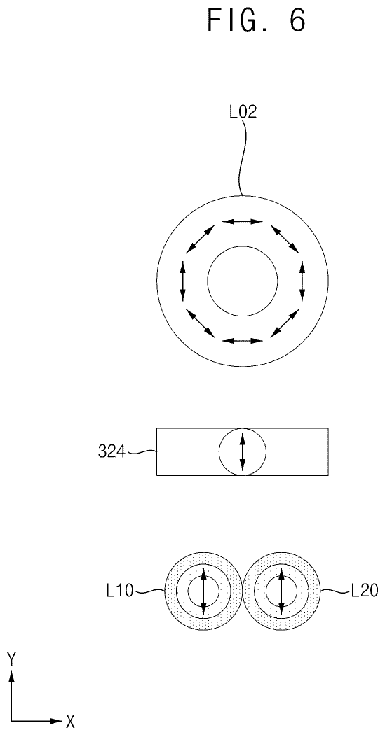

FIG. 1 is a perspective view illustrating a laser processing apparatus in accordance with various example embodiments. FIG. 2 is a block diagram illustrating a laser irradiator of FIG. 1. FIG. 3A is a graph illustrating a shape and an intensity distribution in a radial direction of a laser beam emitted from a laser light source, and FIG. 3B is a graph illustrating a shape and an intensity distribution in a radial direction of a converted laser beam converted by a mode converter. FIG. 4 is a cross-sectional view illustrating a beam expander that expands a diameter of the converted laser beam. FIG. 5 is a diagram illustrating a shape and polarization of a filtered beam of a cylindrical incident beam with azimuthal polarization after passing through a polarization filter. FIG. 6 is a diagram illustrating a shape and polarization of a filtered beam of a cylindrical incident beam with radial polarization after passing through a polarization filter. FIG. 7A is a graph illustrating a shape and wavefront of a filtered beam after passing through a polarizing filter, FIG. 7B is a graph illustrating a shape and wavefront of a filtered beam after passing through a spatial light modulator, and FIG. 7C is a graph illustrating a shape and wavefront of first and second laser beams collected by a condenser lens.

Referring to FIGS. 1 to 7C, a laser processing apparatus 10 may include a stage 20 and a laser irradiator 30. In some example embodiments, the laser processing apparatus 10 may further include a controller 40 connected to the stage 20 and the laser irradiator 30 to control their operations.

In some example embodiments, the controller 40 may be wiredly connected to the stage 20 and/or the laser irradiator 30. Alternatively or additional the controller 40 may be wirelessly connected to the stage 20 and/or the laser irradiator 30. In some example embodiments, the controller 30 may be or may include a processor, and/or may be or include a laptop and/or a desktop and/or a tablet; example embodiments are not limited thereto.

In some example embodiments, the laser processing apparatus 10 may irradiate first and second laser beams L1 and L2 onto and into a substrate W such as a wafer to apply localized high-density energy to first and second focal positions P1 and P2 respectively, to form stealth dicing layers as modified regions. The substrate W may be a 200 mm substrate, or a 300 mm substrate, or a 450 mm substrate; example embodiments are not limited thereto. The laser processing apparatus 10 may simultaneously scan the first and second laser beams L1 and L2 along two cutting lines on the substrate W. Thus, laser-scribed layers as the modified regions may be formed within the substrate W along the two cutting lines. The laser-scribed layers formed along the two cutting lines, i.e., scribe lane regions, may serve as cutting starting regions.

The laser processing apparatus 10 may further include a driving portion configured to move the first and second laser beams L1 and L2 relative to the substrate W. The driving portion may include a stage driver 22 configured to moving the stage 20 along three orthogonal axes, such as along the X, Y, and Z axes. In some cases, the stage driver 22 may rotate the substrate along an angle; however, example embodiments are not limited thereto.

In particular, the stage 20 may be or may include or be included in a movable table that supports the substrate W and is able to move in at least one direction. The stage 20 may be installed to be movable in the X and Y directions on the stage driver 22. The stage driver 22 may include a stage drive mechanism (such as a motor) for moving the stage 20, and the stage driver 22 may move the stage 20 in the X and Y directions in response to a control signal from the controller 40. A moving speed of the stage 20 may be adjustable, for example by the controller 40.

In addition, the driving portion may further include a laser head driver for moving the laser irradiator 30 in the X, Y, and Z axes. For example, the laser head driver may move an optical system of the laser irradiator 30 in the X, Y, and Z directions. Alternatively or additionally, the laser head driver may move the laser irradiator 30 in the Z direction, and the stage driver 22 may move the wafer W in the X and Y directions and may rotate the stage 22 around the center of the wafer W.

For example, the substrate W may include a silicon wafer (Si Wafer), a silicon carbide wafer (SiC Wafer), a gallium arsenide wafer (GaAs Wafer), or a silicon single crystal wafer (Si-Single Crystal Wafer). A thickness of the substrate W may be within a range of 50 μm to 850 μm.

As illustrated in FIG. 2, the laser irradiator 30 may include a laser light source 310 to generate a laser beam L10, a laser beam divider 320 to divide the laser beam LOO into two laser beams L10, L20 in a first horizontal direction (X direction), and a condensing lens 340 to condense the divided two laser beams L10, L20 into first and second laser beams L1 and L2 at first and second spots P1, P2 spaced apart in the first horizontal direction (X direction). The laser beam divider 320 may include a mode converter 322 and a polarization filter 324. The laser irradiator 30 may further include an index adjuster 330 to adjust a spacing distance V1 in the first horizontal direction (X direction) between the first and second spots P1 and P2. The index adjuster 330 may include at least one of a beam expander 332 and a spatial light modulator 334.

In particular, the laser light source 310 may emit the laser beam L00 as a single light source. The laser beam L00 may have a wavelength band having transparency to the substrate W, which is an object to be processed. The wavelength band may be within a wavelength range of 1080 nm to 1100 nm. The laser light source 310 may emit a pulsed laser beam. However, example embodiments are not limited thereto, and a continuous wave laser beam may be emitted depending on a type of a processing operation. The laser beam L00 may be an ultrashort pulse laser beam having a pulse width of 1 μs or less, for example, on the order of picoseconds or femtoseconds.

The laser light source 310 may include a solid medium for passing the laser beam. Properties of the laser beam may vary depending on the solid medium. For example, the solid medium may include be or may include at least one of ytterbium yttrium aluminum garnet compound (Yb:YAG), neodymium yttrium aluminum garnet compound (Nd:YAG), neodymium yttrium orthovanadate compound (Nd:YVO4), aluminum gallium arsenide compound, aluminum gallium indium compound (AlGaInP), gallium nitride compound (GaN), neodymium optical fiber (Nd-Fiber), sapphire, etc.

The mode converter 322 may convert the laser beam L00 into a cylindrical vector beam (CVB) L01. The mode converter 322 may be installed inside the laser head or on an optical path of the laser beam L00 after the laser head. The mode converter 322 may convert the laser beam L00 generated by the laser light source 310 into a high-order mode laser beam. The mode converter 322 may convert only a shape of the laser beam into a donut shape (or a single-o shape) without changing the basic characteristics of the laser beam. For example, the mode converter 322 may convert a mode of the laser beam L00 by using birefringence, using a dichroic material, or using an interferometer.

As illustrated in FIGS. 3A and 3B, the laser beam L00 generated by the laser light source 310 may include a Gaussian beam (or Gaussian-shaped beam having a Gaussian-shaped spot), and the cylindrical vector beam laser L01 converted and emitted by the mode converter 322 may have a donut laser mode (or single-o shaped laser mode).

The beam expander 332 may be provided on the optical path of the cylindrical vector beam L01 and may expand the cylindrical vector beam L01. An expanded laser beam L02 expanded by the beam expander 332 may be incident on the polarization filter 324. The beam expander 332 may expand a diameter of a collimated input beam and may emit a collimated output beam having a larger diameter.

As illustrated in FIG. 4, the beam expander 332 may include a combination of a plurality of lenses. The beam expander 332 may adjust a beam size while maintaining the same output value. The spacing distance V1 in a direction such as the first horizontal direction (X direction) between the first and second spots P1 and P2 may be determined according to the diameter of the laser beam L02 expanded by the beam expander 322. For example, the diameter or the full-width at half max (FWHM) of the laser beam L02 expanded by the beam expander 332 may be expanded to several times a distance between two cutting lines on the substrate W.

The polarization filter 324 may polarize the expanded cylindrical vector beam L02 to form a ∞ double-o shaped beam in which two beams L10 and L20 are arranged adjacent to each other in the first horizontal direction (X direction). As used herein, a double-o shape may indicate two “o” shapes joined together, and in some cases may be referred to as or may have the shape of a sideways figure-8, or the shape of an infinity-symbol (or, an ∞ symbol), or the shape of a double-torus. There may be two lobes, or two o's, in such a shape, and a diameter of each o may be the same as, or different from, each other. In some cases, the two lobes or two o's may connect, e.g., may kiss and connect at a single point; alternatively, in some cases, the two lobes or two o's may not connect and may not kiss at a single point. The cylindrical vector beam L02 may have various polarization states by the mode converter 322. The polarization filter 324 may function as a filter that passes only components polarized in a specific direction.

As illustrated in FIG. 5, when the cylindrical vector beam L02 has radial polarization, the polarization filter 324 may allow only components polarized in a direction parallel to the first horizontal direction (e.g., X direction) to pass. The two beams L10 and L20 filtered by the polarization filter 324 may have polarization components in the direction parallel to the first horizontal direction (X direction).

As illustrated in FIG. 6, when the cylindrical vector beam L02 has azimuthal polarization, the polarization filter 324 may allow only components polarized in a direction perpendicular to the first horizontal direction (X direction) to pass. The two beams L10 and L20 filtered by the polarization filter 324 may have polarization components in the direction perpendicular to the first horizontal direction (X direction).

The spatial light modulator (SLM) 334 may be provided on the optical path of the double-o shaped beams L10 and L20 and may modulate a phase of the double-o shaped beams L10 and L20. The spatial light modulator 334 may be an optical device that is able to spatially modulate a beam. The spatial light modulator 334 may include optical elements in a form of a two-dimensional array and may change the phase of an incident laser beam on a pixel basis. The spatial light modulator 334 may spatially control the phase of the laser beam. The spatial light modulator 334 may change only the phase without changing the shape of the waveform. The spatial light modulator 334 may adjust the wavefront such that the double-o shaped beams L10 and L20 are condensed into two condensing points by the condensing lens 340.

As illustrated in FIGS. 7A and 7B, a wavefront WF2 of the double-o shaped beams L11 and L21 that passed through the spatial light modulator 334 may be different from a wavefront WF1 of the two beams L10 and L21 filtered by the polarization filter 324, and the shape of the double-o shaped beams L11 and L21 passing through the spatial light modulator 334 may remain to be the same as the shape of the two beams L10 and L20 filtered by the polarization filter 324.

The condensing lens 340 may condense the double-o shaped beams L11 and L21 that have passed through the spatial light modulator 334 into first and second laser beams L1 and L2 at first and second spots P1 and P2 that are spaced apart in the first horizontal direction (X direction) on the substrate W. The condensing lens 340 may be provided on an optical path of the double-o shaped beam and may include a single lens optical system having numerical aperture (NA) of at least 0.6.

For example, the condensing lens 340 may include the single lens optical system in which a plurality of lenses are sequentially arranged along the optical path. As illustrated in FIG. 7C, the double-o shaped beams L11 and L21 may pass through the single lens optical system to be condensed into the first and second laser beams L1 and L2 respectively. The spacing distance V1 between the first and second spots P1 and P2 on the substrate W as focal positions of the first and second laser beams L1 and L2 may be within a range of 0.5 mm to 20 mm.

The first and second spots P1 and P2 may be local positions where the first and second laser beams L1 and L2 are focused. When the substrate W is a wafer such as a silicon wafer or a germanium wafer or a silicon-germanium wafer or a silicon-on-insulator (SOI) wafer, a plurality of die regions D may be arranged in a matrix shape and divided by the scribe lane regions. The number of, and/or the dimensions of, the die regions D is not limited to FIG. 1. In some example embodiments, the number of die regions D may be greater than, or less than, that illustrated in FIG. 1. In some example embodiments, the die regions D may be rectangular, e.g., may be square; example embodiments are not limited thereto. In some cases, the die regions D may or may not extend to the edge of the substrate W.

The driving portion of the laser processing apparatus 10 may move the first and second laser beams L1 and L2 with respect to the substrate W in a second horizontal direction different from, e.g., perpendicular to, the first horizontal direction (X direction) such that the first and second laser beams L1 and L2 are simultaneously scanned along two cutting lines or kerf lines on the substrate W. For example, the second horizontal direction may be a direction (Y direction) perpendicular to the first horizontal direction (X direction).

The stage 20 may be moved in one direction by the stage driver 22 at a scanning speed (such as a dynamically determined speed, or, alternatively, a preset scanning speed). The scanning speed of the first and second laser beams L1 and L2 may be determined by the speed of the stage 20. The scanning speed of the first and second laser beams L1 and L2 may be within a range of 300 mm/s to 2000 mm/s. In some cases, the scanning speed of the first and second laser beams L1 and L2 may be the same as, or different from, each other. In some cases, the scanning speed of the first and second laser beams L1 and L2 may be constant, or, alternatively, may vary along the dimensions of the substrate W.

As mentioned above, the laser processing apparatus 10 may include the laser beam divider 320 to convert the laser beam L00 emitted from the laser light source 310 as the single light source into the double-o shaped beam in which the two beams L10 and L20 are arranged adjacent to each other in the first horizontal direction (X direction), and the condensing lens 340 to condense the double-o shaped beam into the first and second laser beams L1 and L2 at the first and second spots P1 and P2. In addition, the laser processing apparatus 10 may further include the index adjuster 330 to adjust the spacing distance in the first horizontal direction (X direction) between the first and second spots P1 and P2.

The first and second laser beams L1 and L2 may be simultaneously scanned along two cutting lines on the substrate W. The distance between the first and second spot positions P1 and P2 of the first and second laser beams L1 and L2 may be adjusted according to a size of (or a dimension of, such as a width and/or a length of) the die that is to be diced from the substrate W. The first and second laser beams L1 and L2 may be focused by the single lens optical system.

Accordingly, the first and second laser beams L1 and L2 may be simultaneously scanned while tracking a surface height in real time along two adjacent cutting lines, without increasing a size of the optical system or replacing a new optical system. Thus, a productivity of the dicing process may be improved. Alternatively or additionally, the distance between the two first and second laser beams L1 and L2 may be more easily adjusted optically.

Hereinafter, a laser processing method using the laser processing apparatus of FIG. 1 will be described.

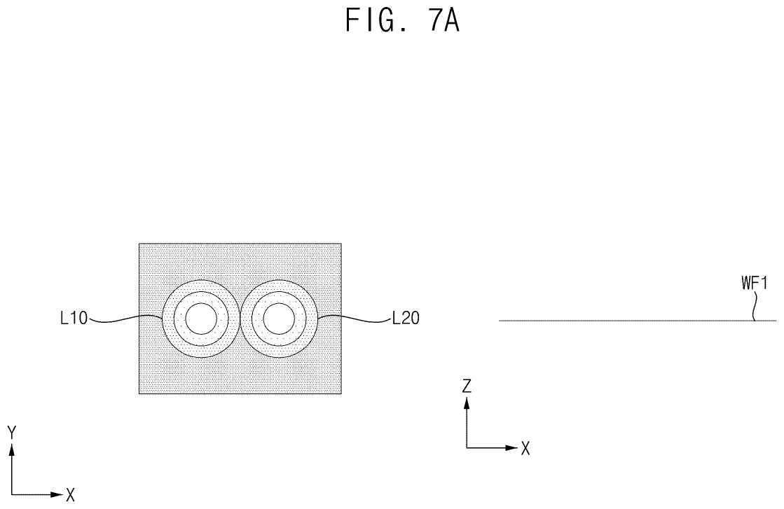

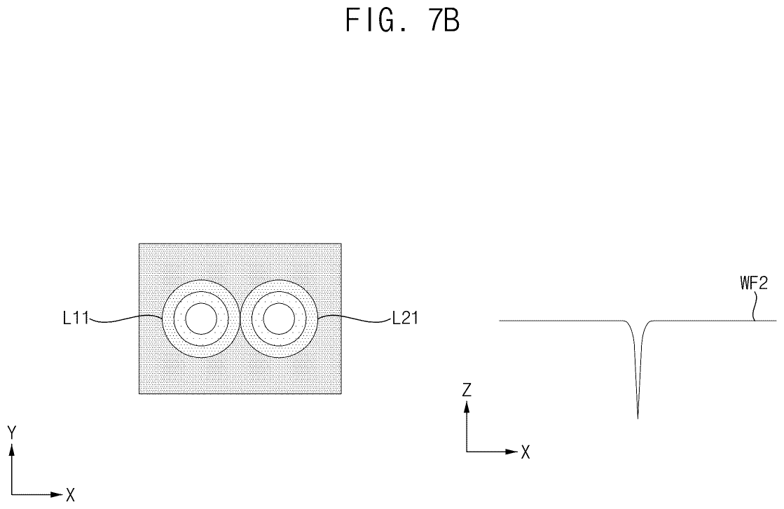

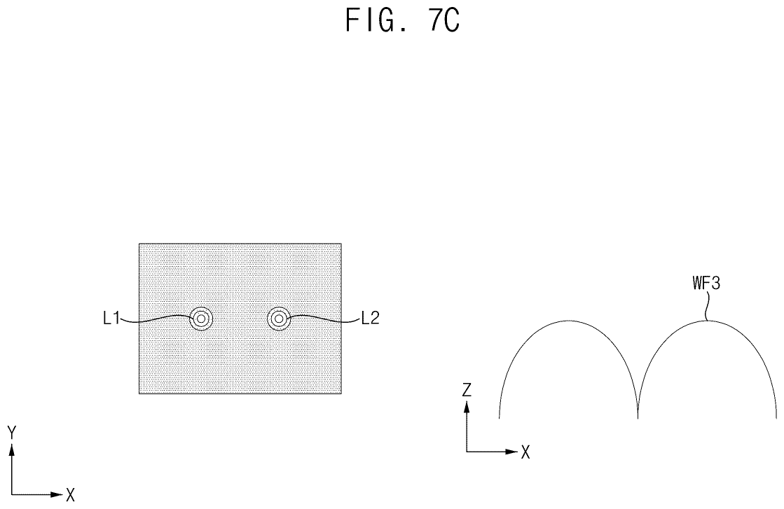

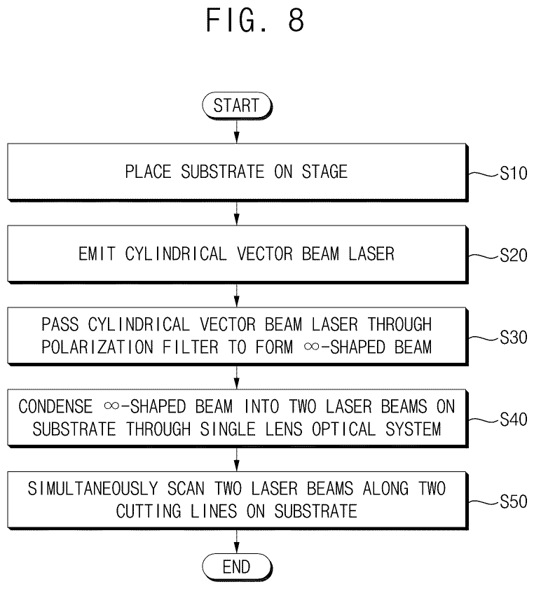

FIG. 8 is a flow chart illustrating a laser processing method in accordance with example embodiments. FIG. 9 is a cross-sectional view illustrating a wafer on which two first and second laser beams are irradiated. FIG. 10 is a plan view illustrating two cutting lines on a wafer along which the first and second laser beams of FIG. 9 are scanned. FIG. 11 is a perspective view illustrating the first and second laser beams irradiated along two cutting lines in FIG. 10.

Referring to FIGS. 1 to 9, first, a substrate W, which is or corresponds to an object to be processed, may be supported on a stage 20 (S10), a laser beam L01 of a cylindrical vector beam may be emitted (S20), the cylindrical vector beam L01 may be polarized by a polarization filter 324 to form a double-o shaped beam in which two beams L10 and L20 are arranged adjacently in a first horizontal direction (X direction) (S30), and the double-o shaped beam may be condensed into first and second laser beams L1 and L2 at first and second spots P1 and P2 that are spaced apart in the first horizontal direction (X direction) on the substrate W through a condensing lens 340 (S40). The distance upon which the first and second spots P1 and P2 may be determined, e.g., by a length of or a width of the die regions D.

In some example embodiments, after the substrate W is place on a stage 20 of FIG. 1, a laser beam L00 may be generated by a laser light source 310 as a single light source, and the laser beam L00 may be converted into the cylindrical vector beam L01 by a mode converter 322. For example, the laser beam L00 generated by the laser light source 310 may include a Gaussian beam, and the cylindrical vector beam laser L01 converted and emitted by the mode converter 322 may have a donut laser mode.

In some example embodiments, in order to adjust a spacing distance V1 between the first and second spots P1 and P2 in the first horizontal direction (X direction), the cylindrical vector beam L01 may be expanded by a beam expander 332 that is provided an optical path of the cylindrical vector beam L01. The laser beam L02 expanded by the beam expander 332 may have a diameter greater than a diameter of the cylindrical vector beam L01.

Then, the polarization filter 324 may polarize the expanded cylindrical vector beam L02 to form the double-o shaped beam in which two beams L10 and L20 are arranged adjacently in the first horizontal direction (X direction). The cylindrical vector beam L02 may have various polarization states by the mode converter 322. The polarization filter 324 may function as a filter that passes only components polarized in a specific direction.

For example, when the cylindrical vector beam L02 has radial polarization, the polarization filter 324 may pass only components polarized in a direction parallel to the first horizontal direction (X direction). The two beams L10 and L20 filtered by the polarization filter 324 may have polarization components in the direction parallel to the first horizontal direction (X direction).

Alternatively, when the cylindrical vector beam L02 has azimuthal polarization, the polarization filter 324 may pass only components polarized in a direction perpendicular to the first horizontal direction (X direction). The two beams L10 and L20 filtered by the polarization filter 324 may have polarization components in the direction perpendicular to the first horizontal direction (X direction).

In some example embodiments, a phase of the double-o shaped beam may be modulated by a spatial light modulator 334 that is provided on the optical path of the double-o shaped beam. The spatial light modulator 334 may spatially control the phase of the laser beam. The spatial light modulator 334 may change only the phase without changing the shape of the waveform.

For example, a wavefront of the double-o shaped beams L11 and L21 that have passed through the spatial light modulator 334 may be changed, while a shape of the double-o shaped beams L11 and L21 that have passed through the spatial light modulator 334 may not be changed to be the same as the shape of the two beams L10 and L20 filtered by the polarization filter 324.

Then, the condensing lens 340 may condense the double-o shaped beams L11 and L21 that have passed through the spatial light modulator 334 into the first and second laser beams L1 and L2 at the first and second spots that are spaced apart in the first horizontal direction (X direction) on the substrate W. The condensing lens 340 may be provided on an optical path of the double-o shaped beam and may include a single lens optical system having numerical aperture (NA) of 0.6 or more.

For example, the condensing lens 340 may include the single lens optical system in which a plurality of lenses are sequentially arranged along the optical path. The double-o shaped beams L11 and L21 may pass through the single lens optical system and be condensed into the first and second laser beams L1 and L2 respectively. The spacing distance V1 between the first and second spots P1 and P2 on the substrate W, which correspond to focal positions of the first and second laser beams L1 and L2 may be within a range of 0.5 mm to 20 mm. The spacing distance V1 may be the same, or different, depending on the orientation of the substrate W on the sage 20, and along which lines are to be diced.

Referring to FIGS. 10 and 11, the first and second laser beams L1 and L2 may be scanned along two cutting lines S1 and S2 on the substrate W (S50).

The focal points P1 and P2 of the first and second laser beams L1 and L2 may be located within the substrate W, and the first and second laser beams L1 and L2 may be moved in the second horizontal direction (Y direction) relatively to the substrate along the cutting lines S1 and S2. The spacing distance V1 between the first and second spots P1 and P2 may be substantially equal to a spacing distance V2 between the cutting lines S1 and S2. A scanning speed of the first and second laser beams L1 and L2 may be within a range of 300 mm/s to 2000 mm/s. The scanning speed of the first and second laser beams L1 and L2 may be constant, or may be variable (e.g., may increase and decrease), along the scanning of the substrate W through the cutting lines S1 and S2.

Accordingly, as illustrated in FIG. 11, laser-scribed layers M, which are modified regions, may be formed within the substrate W. The laser damage layers B1 and B2 formed along the cutting lines S1 and S2, that is, the scribe lane regions may serve as cutting starting regions. The laser-scribed layer M may be formed either continuously or intermittently.

For example, when the first and second laser beams L1 and L2 are focused within the substrate W, the first and second laser beams may be absorbed in the first and second spots P1 and P2 to be melted, expanded, contracted and solidified. In the contraction process, both side regions of each of the first and second spots P1 and P2 may be contracted earlier so that a crack begins to appear in the middle region each of the first and second spots P1 and P2, and after the contraction stage, the crack may grow in upward and downward directions to form vertical cracks. The first and second laser beams L1 and L2 are irradiated intermittently while moving the first and second laser beams relative to the substrate W along the cutting lines S1 and S2 through the above process, to form stealth dicing lines within the substrate W along the Y axis direction as illustrated in FIG. 11.

Hereinafter, a method of dicing a substrate using the laser processing apparatus and laser processing method described above will be described.

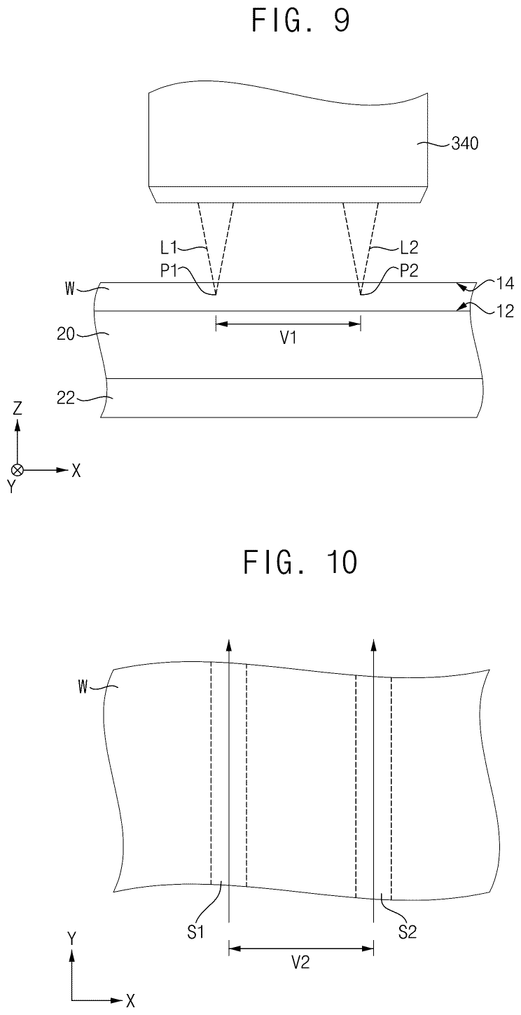

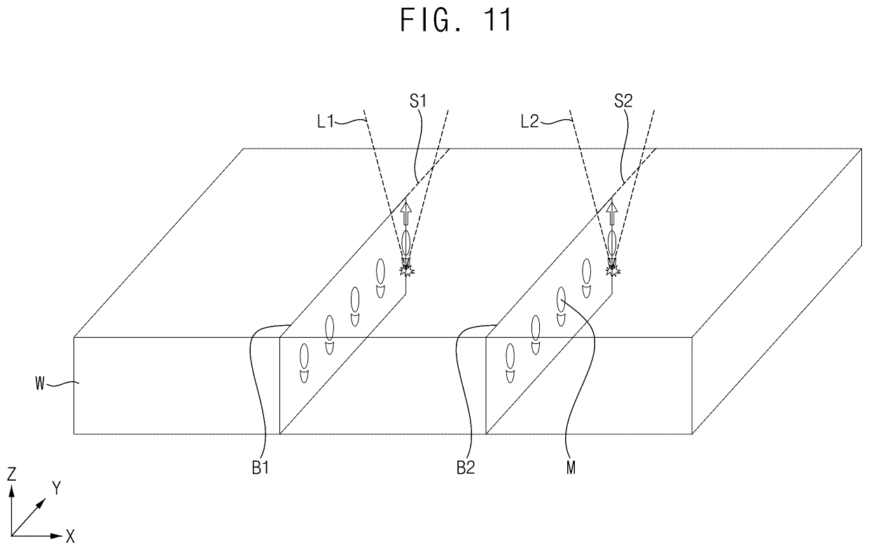

FIG. 12 is a flow chart illustrating a substrate dicing method in accordance with example embodiments. FIGS. 13 to 17 are views illustrating a substrate dicing method in accordance with example embodiments.

Referring to FIGS. 12 to 17, first, a protective tape 110 for protecting circuit elements may be attached onto a first surface (an active surface) 12 of a substrate W (lamination) (S100), and then, first and second laser beams L1 and L2 may be irradiated on a second surface 14 opposite to the first surface 12 of the substrate 10 along two cutting lines to form laser-scribed layers M (S110).

As illustrated in FIG. 13, in some example embodiments, the protective tape 110 may be attached onto the first surface 12 of the substrate W using a tape attachment apparatus 100. The protective tape 110 may protect the circuit elements formed in the first surface 12 of the substrate W.

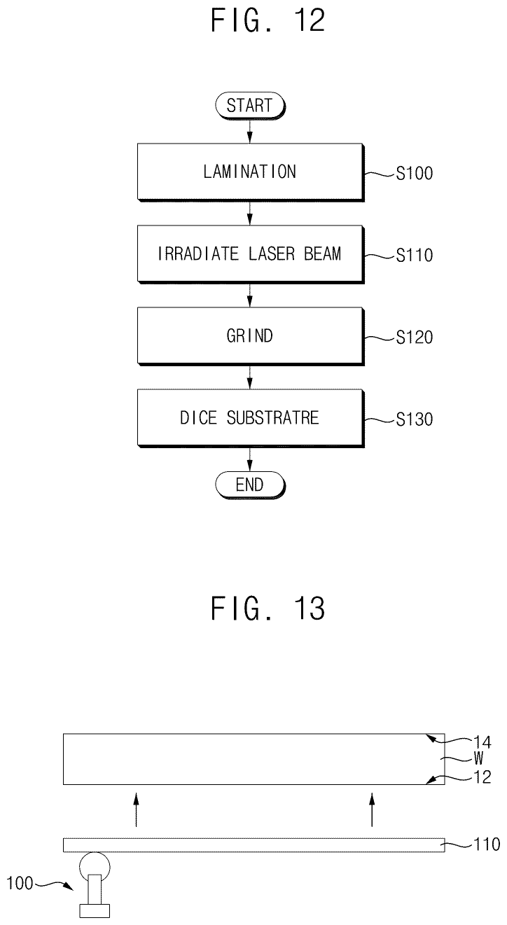

As illustrated in FIG. 14, the first and second laser beams L1 and L2 may be irradiated into the substrate W while locating first and second spots within the substrate W using the laser processing apparatus 10, to form optically damaged portions (laser-scribed layers) M by multiphoton absorption. The first and second laser beams L1 and L2 may be moved relatively to the substrate W along two cutting lines S1 and S2 to form laser damage layers M, which are modified regions, inside the substrate W. The laser damage layers M formed along the cutting lines S1 and S2, that is, scribe lane regions, may be cutting starting regions.

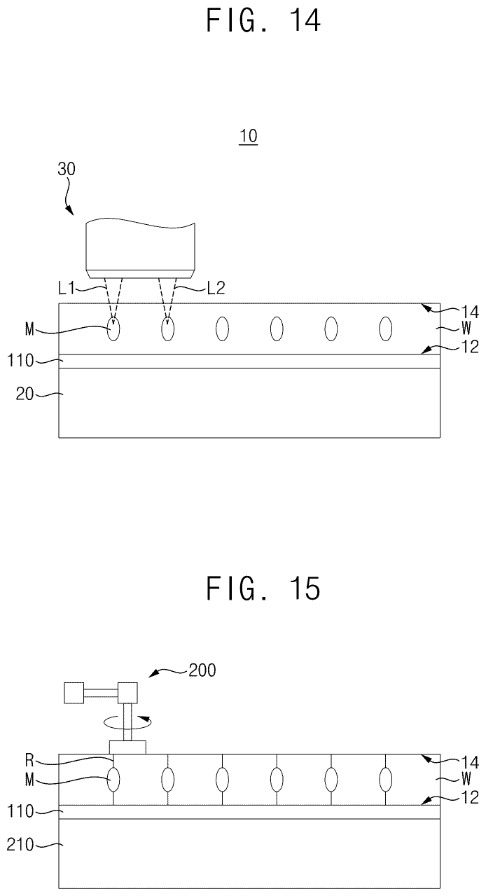

As illustrated in FIG. 15, the second surface 14 of the substrate W in which the laser damage layers M are formed may be grinded using a grinding apparatus 200 (S120). By grinding the second surface 14 of the substrate W, a thickness of the substrate W may be thinned to have a desired thickness. At this time, during the grinding process, the laser damage layers M may function as dicing starting regions, resulting in fine vertical cracks R.

After performing the grinding process, the protective tape 110 may be removed from the substrate W.

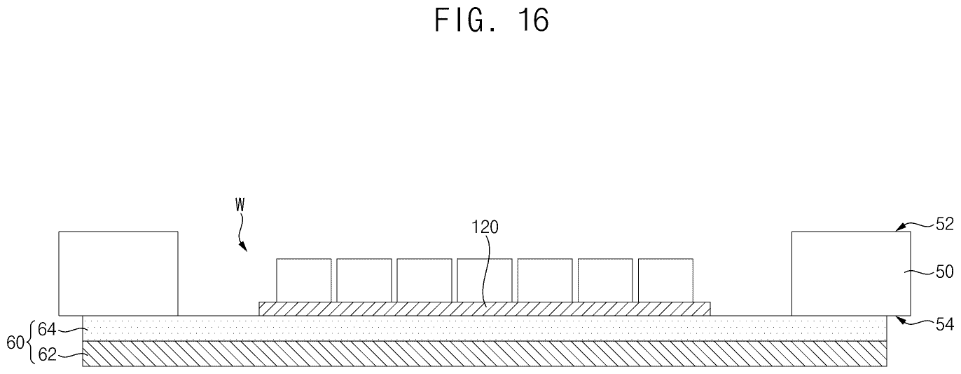

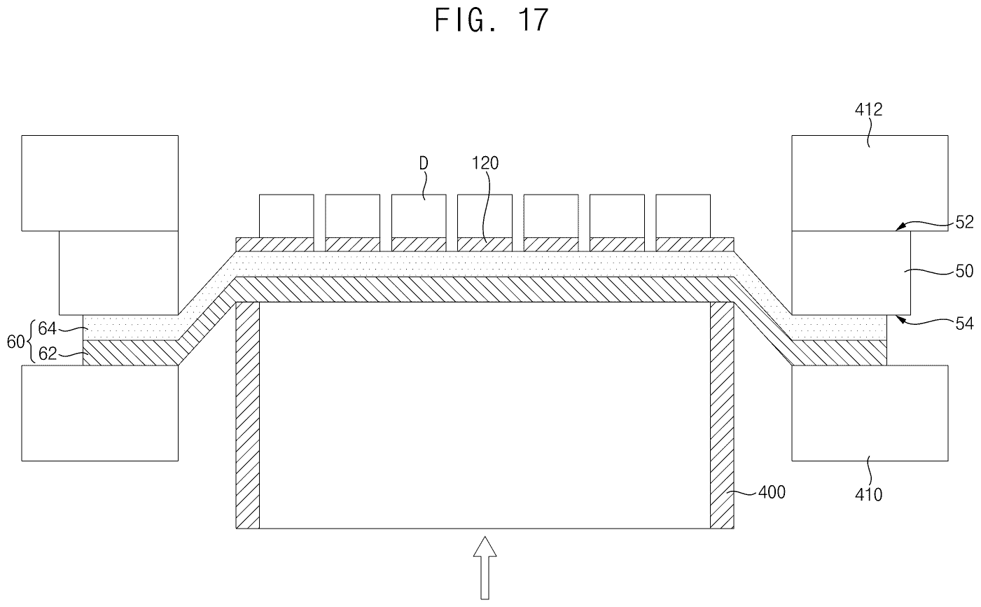

As illustrated in FIGS. 16 and 17, the substrate W may be diced into individual chips (S130).

In some example embodiments, a dicing tape 60 may be attached to a lower surface 52 of a ring frame 50, and an adhesive film 120 may be attached to the substrate W on which a plurality of semiconductor chips are formed. The dicing tape 60 may be attached to the ring frame 50 by an adhesive force of a tacky material layer 64 of the dicing tape 60. The adhesive film 120 may be spaced apart from an inner surface of the ring frame 50. The adhesive film 120 may include a die attach film (DAF) as an organic adhesive.

Then, the dicing tape 60 may be expanded to separate the substrate W into a plurality of semiconductor chips D.

In some example embodiments, after the ring frame 50 and the attachment region of the dicing tape 60 are inserted and fixed between a fixing member 412 and a stage 410, a cylindrical pressing member 400 may be raised to expand the dicing tape 60. Accordingly, the divided chips on the dicing tape 60 may be spaced apart from each other in a radial direction. At this time, the adhesive film 120 may also be separated.

Then, a pick-up process may be performed to pick up the individually separated semiconductor chips D. Accordingly, the semiconductor chip D to which the adhesive film 120 is attached may be attached onto a package substrate or another semiconductor chip to form a semiconductor package.

The semiconductor package formed by the above-described laser processing apparatus may include semiconductor devices such as one or more of logic devices or memory devices. The semiconductor package may include logic devices such as one or more of a central processing units (CPUs), main processing units (MPUs), or application processors (APs), or the like, and volatile memory devices such as DRAM devices, hybrid memory (HBM) devices, or non-volatile memory devices such as one or more of flash memory devices, PRAM devices, MRAM devices, ReRAM devices, or the like.

Any of the elements and/or functional blocks disclosed above may include or be implemented in processing circuitry such as hardware including logic circuits; a hardware/software combination such as a processor executing software; or a combination thereof. For example, the processing circuitry more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc. The processing circuitry may include electrical components such as at least one of transistors, resistors, capacitors, etc. The processing circuitry may include electrical components such as logic gates including at least one of AND gates, OR gates, NAND gates, NOT gates, etc.

The foregoing is illustrative of example embodiments and is not to be construed as limiting thereof. Although a few example embodiments have been described, those skilled in the art will readily appreciate that many modifications are possible in some example embodiments without materially departing from the novel teachings and advantages of the present invention. Accordingly, all such modifications are intended to be included within the scope of variously described example embodiments as defined in the claims. Additionally example embodiments are not necessarily mutually exclusive with one another. For example, some example embodiments may include one or more features described with reference to one or more figures, and may also include one or more other features described with reference to one or more other figures.

1. A laser processing apparatus, comprising:
a stage configured to support a substrate that is an object to be processed;
a laser light source configured to generate a laser beam;
a mode converter configured to convert the laser beam into a cylindrical vector beam;
a polarizing filter configured to polarize the cylindrical vector beam to form a double-o shaped beam in which two beams are arranged adjacent to each other in a first horizontal direction;
a condensing lens configured to condense the double-o shaped beam into first and second laser beams at first and second spots on the substrate, the first and second laser beams spaced apart in the first horizontal direction; and
a driving portion configured to move the first and second laser beams relatively with respect to the substrate in a second horizontal direction different from the first horizontal direction.

2. The laser processing apparatus of claim 1, wherein the laser beam includes a Gaussian beam, and the cylindrical vector beam includes a donut laser mode beam.

3. The laser processing apparatus of claim 1, wherein the polarization filter is configured to pass components polarized in a direction parallel to the first horizontal direction in response to the cylindrical vector beam having radial polarization.

4. The laser processing apparatus of claim 1, wherein the polarization filter is configured to pass components polarized in a direction perpendicular to the first horizontal direction in response to the cylindrical vector beam having azimuthal polarization.

5. The laser processing apparatus of claim 1, wherein the second horizontal direction is perpendicular to the first horizontal direction.

6. The laser processing apparatus of claim 1, further comprising:
an index adjuster on an optical path of the cylindrical vector beam or on the double-o shaped beam or on both the optical path and the double-o shaped beam, the index adjuster configured to adjust a spacing distance in the first horizontal direction between the first and second spots.

7. The laser processing apparatus of claim 6, wherein the index adjuster includes a beam expander on the optical path of the cylindrical vector beam and configured to expand the cylindrical vector beam.

8. The laser processing apparatus of claim 6, wherein the index adjuster includes a spatial light modulator on the optical path of the double-o shaped beam and configured to modulate a phase of the double-o shaped beam.

9. The laser processing apparatus of claim 1, wherein a spacing distance in the first horizontal direction between the first and second spots is within a range of 0.5 mm to 20 mm.

10. The laser processing apparatus of claim 1, wherein the condensing lens is on an optical path of the double-o shaped beam and includes a single lens optical system having numerical aperture (NA) of 0.6 or more.

11. A laser processing apparatus, comprising:
a stage configured to support a substrate to be processed;
a laser irradiator configured to converge and irradiate first and second laser beams on first and second spots on the substrate, the first and second spots spaced apart in a first horizontal direction; and
a driving portion configured to move the stage or the laser irradiator and to move the first and second laser beams with respect to the substrate in a second horizontal direction different from the first horizontal direction,
wherein the laser irradiator includes,
a laser light source configured to generate a laser beam,
a mode converter configured to convert the laser beam into a cylindrical vector beam;
a polarizing filter configured to polarizing the cylindrical vector beam to form a double-o shaped beam in which two beams are arranged adjacent to each other in the first horizontal direction,
a condensing lens on an optical path of the double-o shaped beam and configured to condense the double-o shaped beam into the first and second laser beams on the substrate, and
an index adjuster on the optical path of the cylindrical vector beam or the double-o shaped beam or on both the optical path and the double-o shaped beam, the index adjuster configured to adjust a spacing distance in the first horizontal direction between the first and second spots.

12. The laser processing apparatus of claim 11, wherein the laser beam includes a Gaussian beam, and the cylindrical vector beam includes a laser beam in a donut laser mode.

13. The laser processing apparatus of claim 11, wherein the polarization filter is configured to pas components polarized in a direction parallel to the first horizontal direction in response to the cylindrical vector beam having radial polarization.

14. The laser processing apparatus according to claim 11, wherein the polarization filter is configured to pass components polarized in a direction perpendicular to the first horizontal direction in response to the cylindrical vector beam having azimuthal polarization.

15. The laser processing apparatus of claim 11, wherein the second horizontal direction is perpendicular to the first horizontal direction, and the laser irradiator is configured to scan the first and second laser beams along two cutting lines on the substrate respectively.

16. The laser processing apparatus of claim 15, wherein a scanning speed of the first and second laser beams is within a range of 300 mm/s to 2000 mm/s.

17. The laser processing apparatus of claim 11, wherein the index adjuster includes a beam expander on an optical path of the cylindrical vector beam and configured to expand the cylindrical vector beam.

18. The laser processing apparatus of claim 11, wherein the index adjuster includes a spatial light modulator on an optical path of the double-o shaped beam and is configured to modulate a phase of the double-o shaped beam.

19. The laser processing apparatus of claim 11, wherein the spacing distance in the first horizontal direction between the first and second spots is within a range of 0.5 mm to 20 mm.

20. The laser processing apparatus of claim 11, wherein the condensing lens includes a single lens optical system having numerical aperture (NA) of 0.6 or more.

21.-30. (canceled)
